(19) United States
(12) Patent Application Publication
(10) Pub. No.: US 2019/0384107 A1
(43) Pub. Date: Dec. 19, 2019

(54) POLARIZER, LIQUID CRYSTAL PANEL AND LIQUID CRYSTAL DISPLAY

(71) Applicant: HUIZHOU CHINA STAR OPTOELECTRONICS TECHNOLOGY CO., LTD., Huizhou Guangdong (CN)

(72) Inventors: Bo HAI, Huizhou, Guangdong (CN); Dongze LI, Huizhou Guangdong (CN); Yung-jui LEE, Huizhou, Guangdong (CN); Yuchun HSIAO, Huizhou, Guangdong (CN); Weiwei ZHENG, Huizhou, Guangdong (CN)

(21) Appl. No.: 15/754,257

(22) PCT Filed: Dec. 14, 2017
(86) PCT No.: PCT/CN2017/116038

§ 371 Date: Feb. 21, 2018

(30) Foreign Application Priority Data
Nov. 1, 2017 (CN) 201711057681.5

(51) Int. Cl. G02F 1/1335

(52) U.S. Cl. CPC G02F 1/133528; G02F 2202/36; G02F 1/133621; G02F 1/133617

(57) ABSTRACT

A polarizer is provided. The polarizer comprises an adhesive layer, a viewing angle compensation layer disposed below the adhesive layer, a polarizing layer disposed below the viewing angle compensation layer, a first quantum dot layer disposed below the polarizing layer and a second quantum dot layer disposed below the first quantum dot layer. The first quantum dot layer includes one of a red quantum dot material and a green quantum dot material, and the second quantum dot layer includes the other of the red quantum dot material and the green quantum dot material. The quantum dot layer can replace the original protecting layer, the outermost layer of the polarizer, thereby beneficial to thinning polarizer integrated with the quantum dot material therein. Besides, the polarizer can promote the color gamut of the liquid crystal panel and increase the viewing angle and brightness of the liquid crystal panel.

### RELATED APPLICATIONS

The present application is a National Phase of International Application Number PCT/CN2017/116038, filed Dec. 14, 2017, and claims the priority of China Application 201711057681.5, filed Nov. 1, 2017

### FIELD OF THE DISCLOSURE

The disclosure relates to a display technical field, and more particularly to a polarizer, a liquid crystal panel and a liquid crystal display.

### BACKGROUND

In the past decades, liquid crystal display (LCD) is the most representative display. However, in recent years, the new display technologies, such as organic electroluminescence display and laser display, are developed one after another, and lead to a great trend to replace the conventional LCD. Under the circumstances, LCD is also constantly upgrading, by using innovative technology and design to make up their deficiencies. Quantum dots (QDs) are one of the most useful attempts.

The QDs material has the excellent properties such as high color purity and adjustable continuous spectrum, so becomes the most outstanding luminescent material in 21st century. The QDs material may greatly improve the display performance on color gamut of the current LCD, so the applications thereof are widely studied in recent years.

Besides promoting the color gamut, the QDs material can be applied for increasing viewing angle of the display by its non-directional selectivity of fluorescent radiation. Indeed, for the current LCD, the viewing angle is one of the important evaluation criteria, but since the limitation to the factors of displaying mode and backlight design, the displaying performance of wide viewing angle is far worse than that of zero viewing angle for the displays such as the twisted nematic (TN) type LCD or the vertical alignment (VA) type LCD.

The QDs material uses primarily the light conversion characteristics for converting blue light of high energy level to white light of high color purity. The QDs material can convert the light, and can generate electronic transition and then emit fluorescent radiation through electron hole recombination. As a typical zero-dimensional nanomaterial, the size of the QDs material in any direction is within the range of quantum confinement, so the fluorescent radiation is also without directional selectivity and emitting in all the directions with no difference. Therefore, the QDs material can be applied to balance the situation of each viewing angle, thereby to improve the viewing angle characteristics.

Besides, the liquid crystal panel usually has the polarizer, and the current polarizer of the liquid crystal panel is without the QDs material. Therefore, how to integrate the QDs material into the polarizer is a technical problem demanded to be solved.

### SUMMARY

For solving the problems of current technology, the present invention provides a polarizer. The polarizer comprises an adhesive layer; a viewing angle compensation layer, disposed below the adhesive layer; a polarizing layer, disposed below the viewing angle compensation layer; a first quantum dot layer, disposed below the polarizing layer; and a second quantum dot layer, disposed below the first quantum dot layer, wherein the first quantum dot layer includes one of a red quantum dot material and a green quantum dot material, and the second quantum dot layer includes the other of the red quantum dot material and the green quantum dot material.

Further, the first quantum dot layer includes the red quantum dot material, and the second quantum dot layer includes the green quantum dot material.

Further, a concentration of the green quantum dot material in the second quantum dot layer is larger than a concentration of the red quantum dot material in the first quantum dot layer.

Further, the first quantum dot layer includes the green quantum dot material, and the second quantum dot layer includes the red quantum dot material.

Further, a concentration of the green quantum dot material in the first quantum dot layer is larger than a concentration of the red quantum dot material in the second quantum dot layer.

Further, at least one of the first quantum dot layer and the second quantum dot layer comprises a dispersion solvent and a polymer-based material.

Further, the dispersion solvent includes at least one of N-pentane, N-hexane, N-heptane, cyclopentane, cyclohexane, dichloromethane, trichloromethane, toluene and petroleum ether.

Further, the polymer-based material includes at least one of acrylic resin, epoxy resin, cyclic olefin polymers, organosilane resin and fiber ester.

In another respect, the present invention also provides a liquid crystal panel comprising the above polarizer.

In another respect, the present invention also provides a liquid crystal display comprising the above liquid crystal panel: and a backlight module, relative to the liquid crystal panel, to provide a blue light for the liquid crystal panel.

The advantages of the present invention are as follows. The present invention provides a polarizer integrated with a quantum dot material therein. The quantum dot layer can replace the original protecting layer, the outermost layer of the polarizer, thereby beneficial to thinning polarizer integrated with the quantum dot material therein. Besides, the polarizer can promote the color gamut of the liquid crystal panel and increase the viewing angle and brightness of the liquid crystal panel.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. In the figures:

FIG. 1 is a structure view of a liquid crystal panel in an embodiment of the present invention; and

FIG. 2 is a structure view of a liquid crystal display in an embodiment of the present invention.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the drawings, the thickness of layers and regions are exaggerated for clarity. Same numbers refer to same elements throughout the specification.

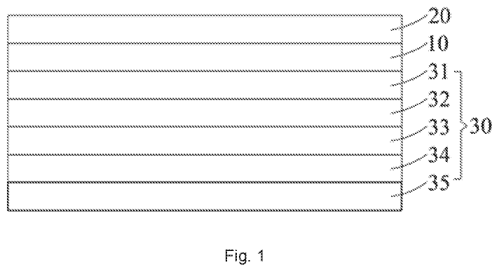

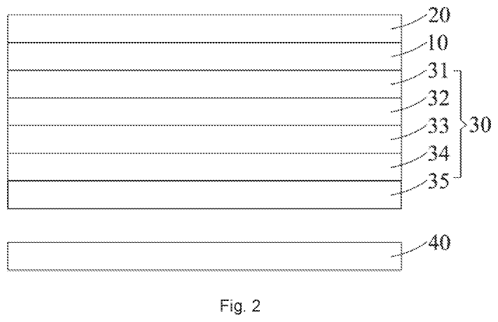

FIG. 1 is a structure view of a liquid crystal panel in an embodiment of the present invention. FIG. 2 is a structure view of a liquid crystal display in an embodiment of the present invention.

Referring to FIG. 1 and FIG. 2, in an embodiment of the present invention, the liquid crystal display comprises a liquid crystal panel 50 and a backlight module 40. It should be understood, the liquid crystal display in the first embodiment of the present invention also comprises other necessary components. The liquid crystal panel 50 comprises a liquid crystal box 10, an upper polarizer 20 and a lower polarizer 30.

In specific, the liquid crystal box 10 and the backlight module 40 are disposed relative to each other and are fixed together through an outer frame. The liquid crystal box 10 includes an array substrate, a color filter substrate and a liquid crystal layer disposed therebetween. The backlight module 40 includes a backlight source for providing the required back light.

The upper polarizer 20 is attached to a surface of the liquid crystal box 10 back to the backlight module 40, and the lower polarizer 30 is attached to a surface of the liquid crystal box 10 facing the backlight module 40. In this embodiment, the lower polarizer 30 is as an example for illustrating.

In detail, the lower polarizer 30 comprises an adhesive layer 31, a viewing angle compensation layer 32 disposed below the adhesive layer 31, a polarizing layer 33 disposed below the viewing angle compensation layer 32, a first quantum dot layer 34 disposed below the polarizing layer 33 and a second quantum dot layer 35 disposed below the first quantum dot layer 34. The first quantum dot layer 34 only includes a green quantum dot material. The second quantum dot layer 35 only includes a red quantum dot material. Further, the quantum dots are integrated within the lower polarizer 30 for implementing the thinner polarizer.

The adhesive layer 31 herein is usually made of the polypropylene glue for adhering to the liquid crystal box 10. The viewing angle compensation layer 32 is serving as a protecting layer of the polarizing layer 33, for isolating water vapor and compensating the viewing angle. The polarizing layer 33 is serving as the core layer for polarizing and analyzing of the lower polarizer 33.

The first quantum dot layer 34 includes green quantum dots, a dispersion solvent and a polymer-based material. The green quantum dots are made of oil-soluble materials. The dispersion solvent is non-polar and includes at least one of N-pentane, N-hexane, N-heptane, cyclopentane, cyclohexane, dichloromethane, trichloromethane, toluene and petroleum ether. The preferred dispersion solvent is the mixed solvent including at least one of N-hexane, cyclohexane and toluene. The polymer-based material includes at least one of acrylic resin, epoxy resin, cyclic olefin polymers, organosilane resin and fiber ester. The preferred polymer-based material is the good barrier material including at least one of cyclic olefin polymers and organosilane resin.

The second quantum dot layer 35 includes red quantum dots, a dispersion solvent and a polymer-based material. The red quantum dots are made of oil-soluble materials. The dispersion solvent is non-polar and includes at least one of N-pentane, N-hexane, N-heptane, cyclopentane, cyclohexane, dichloromethane, trichloromethane, toluene and petroleum ether. The preferred dispersion solvent is the mixed solvent including at least one of N-hexane, cyclohexane and toluene. The polymer-based material includes at least one of acrylic resin, epoxy resin, cyclic olefin polymers, organosilane resin and fiber ester. The preferred polymer-based material is the good barrier material including at least one of cyclic olefin polymers and organosilane resin.

In another embodiment of the present invention, a concentration of the green quantum dots in the first quantum dot layer 34 is larger than a concentration of the red quantum dots in the second quantum dot layer 35. Because the light with shorter wavelength has higher energy, only the light with a wavelength shorter than the corresponding wavelength of the quantum dot material can excite the quantum dot material when the light is passing through. Therefore, when the second quantum dot layer 35 is the outer layer, the red light generated by the excitation of blue light is unable to excite the green quantum dots in the first quantum dot layer 34. If the concentration of the red quantum dots in the second quantum dot layer 35 is larger, more blue light would be absorbed to excite more red light, thereby to decrease the proportion of blue light for exciting the green quantum dots in the first quantum dot layer 34. It is adverse to the exciting efficiency of the green quantum dots in the first quantum dot layer 34.

In a further embodiment of the present invention, the first quantum dot layer 34 includes only the red quantum dots, and the second quantum dot layer 35 includes only the green quantum dots. Further, a concentration of the green quantum dots in the second quantum dot layer 35 is larger than a concentration of the red quantum dots in the first quantum dot layer 34. Thus, the amount of phosphor material needed can be reduced, thereby to decrease the cost. Besides, because the light with shorter wavelength has higher energy, only the light with a wavelength shorter than the corresponding wavelength of the quantum dot material can excite the quantum dot material when the light is passing through. Therefore, the blue light and the green light generated by the excitation of blue light both can excite the red quantum dots in the first quantum dot layer 34, thereby to promote the exciting efficiency.

The backlight source of the backlight module 40 may be a blue LED, so the backlight module 40 can emit high energy of blue light to the liquid crystal panel 50.

According to the embodiment of the present invention, a polarizer integrated with a quantum dot material therein is provided. The quantum dot layer can replace the original protecting layer, the outermost layer of the polarizer, thereby beneficial to thinning polarizer integrated with the quantum dot material therein. Besides, the polarizer can promote the color gamut of the liquid crystal panel and increase the viewing angle and brightness of the liquid crystal panel.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application.

What is claimed is:

1. A polarizer, comprising:
an adhesive layer;
a viewing angle compensation layer disposed below the adhesive layer;
a polarizing layer disposed below the viewing angle compensation layer;
a first quantum dot layer disposed below the polarizing layer; and
a second quantum dot layer disposed below the first quantum dot layer, wherein the first quantum dot layer includes one of a red quantum dot material and a green quantum dot material, the second quantum dot layer includes the other of the red quantum dot material and the green quantum dot material.

2. The polarizer according to claim 1, wherein the first quantum dot layer includes the red quantum dot material, and the second quantum dot layer includes the green quantum dot material.

3. The polarizer according to claim 2, wherein a concentration of the green quantum dot material in the second quantum dot layer is larger than a concentration of the red quantum dot material in the first quantum dot layer.

4. The polarizer according to claim 1, wherein the first quantum dot layer includes the green quantum dot material, and the second quantum dot layer includes the red quantum dot material.

5. The polarizer according to claim 4, wherein a concentration of the green quantum dot material in the first quantum dot layer is larger than a concentration of the red quantum dot material in the second quantum dot layer.

6. The polarizer according to claim 2, wherein at least one of the first quantum dot layer and the second quantum dot layer further comprises a dispersion solvent and a polymer-based material.

7. The polarizer according to claim 4, wherein at least one of the first quantum dot layer and the second quantum dot layer further comprises a dispersion solvent and a polymer-based material.

8. The polarizer according to claim 6, wherein the dispersion solvent includes at least one of N-pentane, N-hexane, N-heptane, cyclopentane, cyclohexane, dichloromethane, trichloromethane, toluene and petroleum ether.

9. The polarizer according to claim 7, wherein the dispersion solvent includes at least one of N-pentane, N-hexane, N-heptane, cyclopentane, cyclohexane, dichloromethane, trichloromethane, toluene and petroleum ether.

10. The polarizer according to claim 6, wherein the polymer-based material includes at least one of acrylic resin, epoxy resin, cyclic olefin polymers, organosilane resin and fiber ester.

11. The polarizer according to claim 7, wherein the polymer-based material includes at least one of acrylic resin, epoxy resin, cyclic olefin polymers, organosilane resin and fiber ester.

12. A liquid crystal panel, comprising the polarizer of claim 1.

13. A liquid crystal display, comprising:
the liquid crystal panel of claim 12; and
a backlight module opposited to the liquid crystal panel so as to provide a blue light for the liquid crystal panel.
